(19) United States
(12) Patent Application Publication
(10) Pub. No.: US 2020/0145608 A1
(43) Pub. Date: May 7, 2020

(54) Media Production Remote Control and Switching Systems, Methods, Devices, and Configurable User Interfaces

(71) Applicant: Broadcast Pix, Inc., Chelmsford, MA (US)

(72) Inventors: Benjamin B. Taylor, Hollis, NH (US); Michael J. Holten, Billerica, MA (US); Nhan Rao, Winter Park, FL (US); Tobias Pyndt Steinmann, Kobenhavn (DK); John B. Swanton, Westport Island, ME (US)

(73) Assignee: Broadcast Pix, Inc., Chelmsford, MA (US)

(21) Appl. No.: 16/726,890

(22) Filed: Dec. 25, 2019

Related U.S. Application Data
(63) Continuation of application No. 15/955,360, filed on Apr. 17, 2018, now abandoned.
(60) Provisional application No. 62/486,447, filed on Apr. 17, 2017.

(51) Int. Cl. H04N 7/10; H04N 21/438; H04L 29/06; H04H 60/04; H04N 5/268; H04H 20/04

(52) U.S. Cl. CPC H04N 7/104; H04N 21/4384; H04L 65/4092; H04N 7/181; H04N 5/268; H04H 20/04; H04H 60/04

(57) ABSTRACT

A system for processing video input having a media content switcher at one location, one or more video signal sources at a second location, and a control client at a third location. The control client is connected to the media content switcher via a public network and providing an interface to a user for controlling the selection of one or more video signals from the sources and the processing of the one or more signals with one or more media effects. A latency monitoring element may provide monitoring of latency of different network paths of the public network and direct video signals over one or more chosen paths to minimize latency of the source signals.

### RELATED APPLICATIONS

This application is a continuation application of U.S. patent application Ser. No. 15/955,360, entitled “Media Production Remote Control and Switching Systems, Methods, Devices, and Configurable User Interfaces,” filed on Apr. 17, 2018, which is incorporated by reference herein in its entirety.

This application claims the benefit of priority of U.S. Provisional Patent Application Ser. No. 62/486,447, filed on Apr. 17, 2017, and titled “Media Production Remote Control and Switching Systems, Methods, Devices, and Configurable User Interfaces,” which is incorporated by reference herein in its entirety.

### FIELD OF INVENTION

The present invention generally relates to the field of video media production. In particular, the present invention is directed to media production remote control and switching systems, methods, devices, and configurable user interfaces.

### BACKGROUND

Video media production occurs across multiple fields including broadcast, cable, Internet, and satellite programming (e.g., news, commercials, entertainment programming, documentaries, reality shows, music videos, etc.); corporate programming (e.g., events, meetings, conventions, employee educational programming, etc.); product video (e.g., how-to-use, promotional, etc.); educational programming (e.g., distance learning, etc), and more. In some situations, the media produced is viewed by one or more consumers in real-time or near-real-time, often referred to as “live.”

Live production typically involves a live production switcher with an associated control surface that brings together various elements that make up live video/audio production, such as audio, video, pre-recorded media and graphics, etc. Historically, the cameras, microphones, media switcher, and control surfaces have been in close proximity to each other, typically using signal paths that can only traverse short distances. Some recent systems have allowed a limited selection of source devices to be located remotely or for a partial control surface to be operated at a distance from a switcher, both utilizing dedicated network and communication paths.

### SUMMARY OF THE DISCLOSURE

In one implementation, a system for processing video input is provided. The system includes a media content switcher positioned at a first location and having a first connection to a public network; one or more video signal connections configured to provide one or more source video signals over the public network to the media content switcher, the one or more source video signals being from one or more cameras located at a second location remote from the first location; a control client configured to be positioned at a third location remote from the first location and the second location, the control client providing an interface to a user for controlling the selection of the one or more source video signals and the processing of the one or more source video signals with one or more media effects, the control client connected to the media content switcher over the public network.

In another implementation, a system for processing video input is provided. The system includes a media content switcher positioned at a first location and having a first connection to a public network; one or more video signal connections configured to provide one or more source video signals over the public network to the media content switcher, the one or more source video signals being from one or more cameras located at a second location remote from the first location; a control client configured to be positioned at a third location remote from the first location and the second location, the control client providing an interface to a user for controlling the selection of the one or more source video signals and the processing of the one or more source video signals with one or more media effects, the control client connected to the media content switcher over the public network; a control client server configured to communicate with the media content switcher and provide a user interface via the control client for a user to interact with the media content switcher; and a latency monitoring element, the latency monitoring element configured to monitor the latency of a plurality of network paths between the second location and the first location and to direct each of the one or more source video signals over a chosen one or more of the plurality of network paths to minimize latency of the one or more source video signals wherein the latency monitoring element includes machine executable instructions for comparing time codes and/or network path encodings associated with the one or more source video signals to determine a lower latency network path.

In yet another implementation, a system for processing video input. The system includes a media content switcher positioned at a first location and having a first connection to a public network; one or more video signal connections configured to provide one or more source video signals over the public network to the media content switcher, the one or more source video signals being from one or more cameras located at a second location remote from the first location; a control client configured to be positioned at a third location remote from the first location and the second location, the control client providing an interface to a user for controlling the selection of the one or more source video signals and the processing of the one or more source video signals with one or more media effects, the control client connected to the media content switcher over the public network; a control client server configured to communicate with the media content switcher and provide a user interface via the control client for a user to interact with the media content switcher, wherein the control client server includes a web server configured to provide a user interface via a web browser application of a client device, the web server in communication with the media content switcher via the public network and/or a private network for providing interaction between the media content switcher and the client device, wherein the interaction between the media content switcher and the client device includes an interaction selected from the group consisting of providing at least one video signal based on the one or more source video signals from the media content switcher to the user interface, providing a control signal based on an input from a user via the user interface to the media content switcher, providing a camera operator information signal based on information input from a user via the user interface to an operator device located at the second location via the media content switcher, enter text, for editing graphics, and any combinations thereof; and a latency monitoring element, the latency monitoring element configured to monitor the latency of a plurality of network paths between the second location and the first location and to direct each of the one or more source video signals over a chosen one or more of the plurality of network paths to minimize latency of the one or more source video signals wherein the latency monitoring element includes machine executable instructions for comparing time codes and/or network path encodings associated with the one or more source video signals to determine a lower latency network path.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates one embodiment of a system for production of media content;

FIG. 2 illustrates one exemplary implementation of a media content switcher;

FIG. 3 illustrates one example of a media content switcher;

FIG. 4 illustrates various examples of a camera;

FIG. 5 illustrates one exemplary implementation of a media controller;

FIG. 6 illustrates another exemplary implementation of a media controller;

FIG. 7 illustrates yet another exemplary implementation of a media controller;

FIG. 8 illustrates one exemplary implementation of a media controller having a web-based user interface;

FIG. 9 illustrates another exemplary implementation of a media controller having a web-based user interface;

FIG. 10 illustrates one exemplary implementation of a configuration interface for a media controller user interface;

FIG. 11 illustrates another view of an exemplary configuration interface for a media controller user interface;

FIG. 12 illustrates yet another view of the configuration interface of FIG. 11; and

FIG. 13 illustrates a diagrammatic representation of one embodiment of a computing device in the exemplary form of a computer system.

### DETAILED DESCRIPTION

Media production often involves the acquisition of video and audio (e.g., at a studio, public event, sporting event, church service, concert, etc.) from one or more acquisition devices (e.g., cameras, microphones, etc.), selection of audio and/or video from the one or more acquisition devices, processing the audio and/or video (e.g., mixing, fading, adding graphics, adding text, etc.), and outputting a finished media product for real-time viewing. Typically, the devices used for selection, switching, processing, controlling the processing, and outputting the finished media product are located generally in the same location as the one or more acquisition devices. When a need exists to have such tasks located remotely from the one or more acquisition devices, one method that can be utilized is connection via dedicated network and communication paths.

The current disclosure provides systems, methods, and devices for production of real-time media content in which a public network is utilized to connect signals from one or more acquisition devices at a first location to a media content switcher located at a second location remote from the first location.

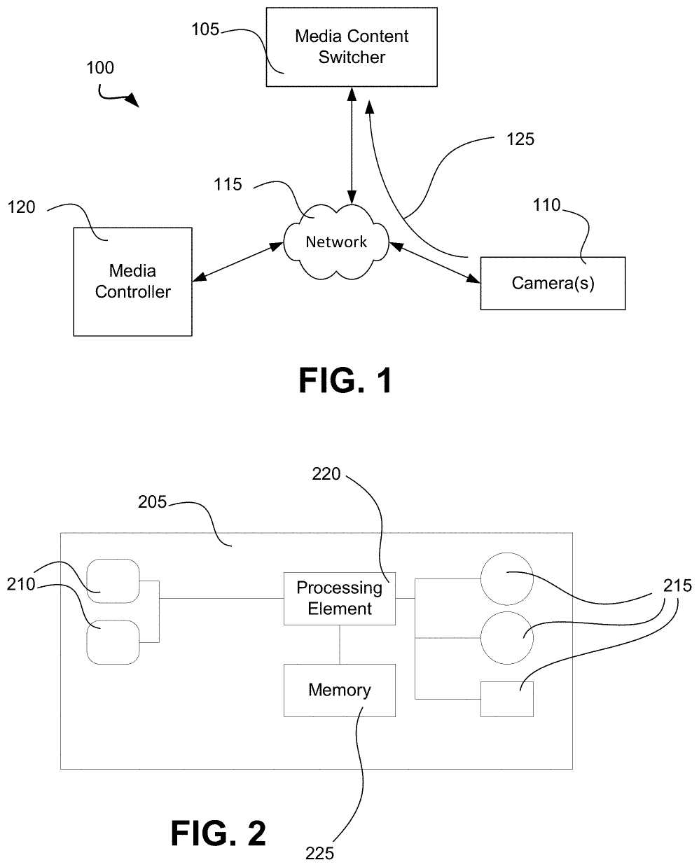

FIG. 1 illustrates one embodiment of a system for production of media content 100. Example media content includes, but is not limited to, video, audio, a computer graphic, a digital photograph, and any combinations thereof. Production of media content involves processing one or more input media content signals (optionally with other data or static media content) to produce a finished media content product. Input media content signals can include media content that is live, stored, generated on the fly, and any combination thereof. Production of media content can include pre-production tasks, live production tasks, etc. In one example, system 100 includes components and functionality for taking live, real-time video media content, processing that media content, and outputting a real-time media content product. System 100 includes a media content switcher 105 connected to one or more cameras 110 via one or more networks 115. A media controller 120 is also connected to the media content switcher 105 via the one or more networks 115.

A media content switcher is a specialized production subsystem having production functionality for providing a finished media product output for real-time viewing and/or media product creation from one or more media source inputs. In one example, a media product output includes video content with or without additional media content. Examples of additional media content include audio, a graphical element, an image (e.g., a fixed image), text, and any combinations thereof. A media content switcher includes inputs for one or more media content signals, processing capabilities, specific circuitry, and access to machine executable instructions for performing one or more switcher functionalities. Example switcher functionalities include, but are not limited to, switching between one or more input media content signals, transforming input signals to the same format and timing, mixing one or more input media content signals, processing one or more input media content signals, providing a preview of one or more input media content signals (e.g., via a display device associated with a media content switcher and/or a media controller), creating and/or defining a show (e.g., a future production for media product output), editing data, storing data, retrieving stored data, transforming data into graphics, applying a special effect to media content, applying a text to a media production, applying a graphic to a media production, applying an animation to a media production, generating a control signal for a content input device (e.g., a camera, a data storage source device, signal router, etc.) associated with a media content switcher, processing a latency control signal, synchronizing one or more input media content signals, receiving and processing one or more command instructions from a media controller, conducting a pre-production task (e.g., processing data for a future production, creating data for a future production, selecting input devices for a future production, programming functionality of an associated media controller for a future production, etc.), performing a production task during receipt of live media content via one or more inputs to the media content switcher, generating transparency information from background color, and any combinations thereof.

Data that may be created, stored, retrieved, utilized with a pre-production task, utilized with a live production task, and/or otherwise processed by a media content switcher includes, but is not limited to, a graphic element, a text element, an animation element, a video element, an audio element, a special effect, a live production command macro, and any combinations thereof. A media content switcher, such as media content switcher 105, may include a content storage source and/or be connected to a separate content storage source for acquisition of data and/or other media content. In one example, a content storage source may be connected to a media content switcher as an input media content signal source. In another example, a media content switcher may include one or more memory elements as a content storage source containing data and/or other stored media content. Stored media content may be utilized with other live media content input by a media content switcher. A content storage source may be connected to a media content switcher via a network (e.g., network 115). A content storage source may include a memory element for storing data and/or media content. Example memory elements are discussed below. Examples of a content storage source include, but are not limited to, an optical disc reader device (e.g., a CD player, a DVD player, etc.), a media tape reading device (e.g., a VCR), a hard drive, a solid-state memory device reader, and any combinations thereof.

A media content switcher may include one or more computing devices. Example computing devices include, but are not limited to, a smartphone, a tablet, an electronic book reading device, a workstation computer, a terminal computer, a server computer, a laptop computer, a personal digital assistant (PDA), a mobile telephone, a portable and/or handheld computing device, a wearable computing device (e.g., a watch), a web appliance, a network router, a network switch, a network bridge, one or more application specific integrated circuits, an application specific programmable logic device, an application specific field programmable gate array, any machine capable of executing a sequence of instructions that specify an action to be taken by that machine (e.g., an optical, chemical, biological, quantum and/or nanoengineered system and/or mechanism), and any combinations thereof.

Components of a media content switcher may be associated with one or more physical devices. Such devices may be geographically dispersed (e.g., connected over network 115). In one example, a media content switcher is distributed over one or more server-type devices and one or more client computing devices (e.g., part of a media controller, such as media controller 120).

FIG. 2 illustrates one exemplary implementation of a media content switcher 205. Media content switcher 205 includes one or more input ports 210 for receiving one or more input media content signals and one or more output ports 215 for outputting one or more produced media products. Media content switcher 205 includes a processing element 220 and a memory element 225. Processing element 220 receives one or more media content signals from one or more input ports 210 and performs a media production task or other switcher functionality. Resulting media product can be output via one or more output ports 215. A processing element includes circuitry capable of performing operations on data (such as performing any one or more of the switcher functionalities discussed above) and processing machine executable instructions. Example processing elements include, but are not limited to, a microprocessor, a microcontroller, a central processing unit, a graphics processing unit, a video processing unit, a field programmable gate array (FPGA), other processors, and any combinations thereof. Memory element 225 may include machine executable instructions for performing tasks associated with the processing of media content (e.g., one or more of the switcher functionalities discussed above) and/or data (e.g., data for use in pre-production, data for use in production, stored media content, etc.). Examples of a memory element include, but are not limited to, a magnetic disk (e.g., a conventional floppy disk, a hard drive disk), an optical disk (e.g., a compact disk “CD”, such as a readable, writeable, and/or re-writable CD; a digital video disk “DVD”, such as a readable, writeable, and/or rewritable DVD), a magneto-optical disk, a read-only memory “ROM” device, a random access memory “RAM” device, a magnetic card, an optical card, a solid-state memory device (e.g., a flash memory), an EPROM, an EEPROM, network attached storage (SAN), and any combinations thereof

Example input ports to a media content switcher (such as media content switchers 105, 205) include, but are not limited to, a network port (e.g., an Ethernet port, a public network protocol port, an Internet port, etc.), a serial data interface (SDI), a coaxial cable connection, a high-definition multimedia interface (HDMI), a video graphics array (VGA) connector, digital visual interface (DVI), a FireWire (IEEE 1394) connector, a DisplayPort connector, a component video connector, universal serial bus (USB), a Bayonet Neill Concelman (BNC) connector, an XLR connector, an AES3 audio connector, an RCA connector, a digital signal connector, an analog signal connector, and any combinations thereof. Example output ports to a media content switch include, but are not limited to, a network port (e.g., an Ethernet port, a public network protocol port, an Internet port, etc.), a serial data interface (SDI), a coaxial cable connection, a high-definition multimedia interface (HDMI), a video graphics array (VGA) connector, digital visual interface (DVI), a FireWire (IEEE 1394) connector, a DisplayPort connector, a component video connector, universal serial bus (USB), a Bayonet Neill Concelman (BNC) connector, an XLR connector, an AES3 audio connector, an RCA connector, a digital signal connector, an analog signal connector, and any combinations thereof. In one example, an input and/or an output port is a connection capable of handling a digital media content signal. In another example, an input and/or an output port is a connection capable of handling an analog media content signal.

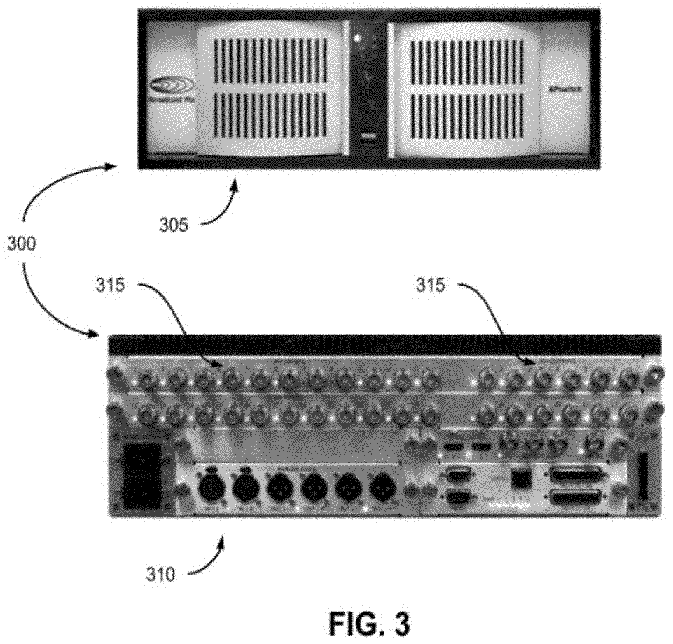

It is noted that some prior media content switchers may have been referred to as workstations in publications. For example, U.S. Pat. Nos. 7,526,568; 7,903,903; 8,028,317; 8,456,571, each of which is incorporated herein by reference in their entirety, described systems that included media content switchers referred to as “workstations.” FIG. 3 illustrates one example of such a media content switcher 300, sold as a model BPSWITCH by Broadcast Pix, Inc. of Chelmsford, Mass., USA. Media content switcher 300 is shown with a front side 305 and a back side 310. Media content switcher 300 includes multiple input and output ports 315 on back side 310. A media content switch of the current disclosure may include configuration and/or functionality of a media content switch as described in the above patents along with one or more aspects of the new configuration and/or functionality disclosed herein as will be apparent from the disclosure of the current application.

Referring again to FIG. 1, one or more networks 115 may be any communication connection that allows communication amongst media content switcher 105, one or more cameras 110, and media controller 120. Example networks include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, a WiFi network, a Bluetooth connection, and any combinations thereof. Any device of the current disclosure (media content switcher 105, one or more cameras 110, media controller 120, a content storage source, etc.) may include a network interface device for communicating with a network. Examples of a network interface device include, but are not limited to, a network interface card (e.g., a mobile network interface circuitry, a LAN card), a modem, USB device, and any combination thereof. In one example, one or more networks 115 includes a public network. In one such example, one or more networks 115 includes the Internet. In such an example with a public network, one or more networks 115 may also include a private network (e.g., a limited access network not accessible by the public). In one exemplary aspect, a benefit of a public network may be that access can be made from anywhere without the cost and time constraints of prior art dedicated network connections between media acquisition devices (e.g., cameras) that are utilized on location and media content switching resources that may be located remotely in the same location as control devices. One or more networks 115 may include other devices (e.g., routers, switches, hubs, etc.) for providing the functionality of such a network.

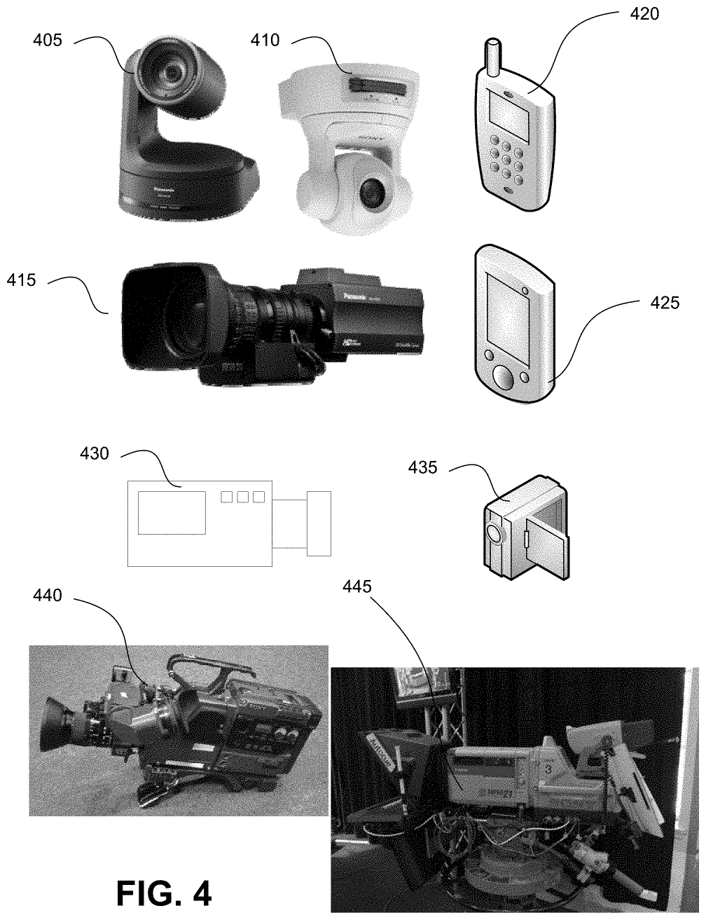

One or more cameras 110 include any device capable of acquiring video. Video acquired by one or more cameras 110 may include audio and/or be associated with a corresponding audio acquisition via a separate device. In one such example, video and audio are combined into a single data signal. In another such example, video and audio are provided from one or more cameras 110 as separate signals. Video acquired by one or more cameras 110 may also have no corresponding audio. Examples of a camera include, but are not limited to, a studio camera, an electronic news gathering (ENG) camera, an electronic field production (EFP) camera, a security camera, a single lens reflex (SLR) camera, a camera of a mobile device (e.g., a camera of a mobile telephone, a mobile smartphone, a mobile tablet device, etc.), a camera of a computing device, a digital camera, an analog camera, and any combinations thereof. FIG. 4 illustrates various examples of a camera: cameras 405, 410, 415 (each having mechanisms for allowing electronic repositioning of aim of video acquisition); camera 420 (an example of a mobile phone having a camera); camera 425 (an example of a mobile smartphone having a camera); camera 430; camera 435 (an example of portable handycam); camera 440 (an example of an ENG camera); and camera 445 (an example of a studio camera).

One or more cameras 110 are connected to media content switcher 105 via one or more media content (e.g., video) signal connections for providing one or more media content signals to media content switcher 105 via network(s) 115. In one example, such a media content signal connection is a communication of data using network(s) 115 and associated wired and/or wireless connectors between associated devices. A media content signal may be transported from a camera at a location where video is acquired to a public network, such as the Internet, using wired and/or wireless mechanisms. At the location of the camera, a local media signal control device may be included to provide certain functionality at the site of the camera, the functionality for assisting with operation of the media content production system. In one example, a local media signal control device is positioned between one or more cameras 110 and one or more networks 115. A local media signal control device includes one or more ports for receiving from one or more cameras 110 media content signals and one or more ports for providing media content signals to media content switcher 105 via network(s) 115. A local media signal control device includes circuitry configured to perform one or more local media signal control tasks. A local media signal control device may also include a memory and/or machine executable instructions for performing one or more local media signal control tasks. In one example, a local media signal control device includes one or more computing devices (e.g., a computing device that includes or is associated with proper ports for receiving and transmitting media content signals and/or other data).

It is noted that connections to a public network may include one or more intermediate connections via a private network (e.g., a network of an Internet Service Provider (ISP), a mobile telephone network, etc.).

Examples of a local media signal control task include, but are not limited to, managing a connection between the camera location and a media content switcher; recording media content; storing media content; communicating a control signal to a media controller (e.g., media controller 120); receiving a control signal from a media controller; receiving a control signal from a media content switcher; providing a control signal to a camera; converting a format of a media content signal to compatibility with network communication; converting a format of a media content signal to reduce size of signal; locating, identifying, and configuring one or more cameras on a network, performing a predetermined set of operations in the event of a loss of media control signals (failsafe), and any combinations thereof.

A local media signal control device may manage a connection between a camera location and a media content switcher. In one example of management, a local media signal control device provides a mechanism to address cameras at the camera location that exist behind a public network firewall (e.g., behind an Internet router between the Internet and the internal operation of the location, such as the internal network of the location). Such a firewall may prevent a remotely located media content switcher from being able to address devices inside the firewall in order to commence communication with those devices. In such a case, a remote media content switcher may not be able to open a session for receiving media content from a camera. In one example of an environment of one or more cameras behind a local firewall, a local media signal control device includes connections to one or more cameras at the location and a connection to the public network via a local network of the location (e.g., a network connected to a router that is connected to the Internet). A local media signal control device can include a processor, appropriate circuitry, and/or machine executable instructions for contacting the media content switcher over the public network to establish a connection and to identify one or more cameras that will be providing the media content switcher with media content. A camera in such an environment may be configured to have its media content pulled from another device. In such a setup, the local media signal control device can negotiate a communication session with the camera and “pull” the media content to the local media signal control device. Then the local media signal control device can “push” a media content signal to a media content switcher over a public network. In another example of an environment of one or more cameras behind a local firewall, a local media signal control device includes a connection to a local network behind the firewall, a processor, appropriate circuitry, and/or machine executable instructions for communicating with the device having the firewall via a communication protocol (e.g., UPnP) for opening a port through the firewall for each camera media content signal coming from inside the firewall so that a media content switcher can communicate through the firewall via the open port to the camera. Combinations of different management examples in a local media signal control device are contemplated.

A media content signal between a camera at the media acquisition location and network(s) 115 (e.g., via a local media signal control device) may be in any of a variety of signal formats. Formats of media content from one or more cameras include, but are not limited to, Windows Media Video (WMV) format, a Flash Video (FLV) format, a QuickTime File Format (MOV), a WebM format, a Moving Pictures Experts Group (MPEG) format (e.g., MPEG-1, MPEG-2, MPEG-4), an M4V format, a RealMedia (RM) format, a RealMedia Variable Bitrate (RMVB) format, an AVI format, a Matroska Multimedia (MKV) format, a Video Object (VOB) format, an RTMP format, an RTSP format, and any combinations thereof. A video may be in the form of one or more streams of video. Data representing a video may be in a format that is compressed. Examples of a compression format include, but are not limited to, H.120, H.261, H.262, H.263, H.264, H.265, VC-2, MPEG-2, MPEG-4, VP8, VP9, MJPEG, JPEG 2000, and any combinations thereof.

Data formats for transmission over a network, such as a public network, may differ from those that are received from a camera device. In some such examples, a full file format transformation may be required. In other examples, a more subtle modification to data, such as packaging the data into a form suitable for network transport without modification of the video format, may be undertaken. Example data formats for transmission over a network include, but are not limited to, Internet protocol format, MPEG-TS, RTP, and any combinations thereof.

In one example, a local media signal control device may perform a file format transformation on a media content signal as it is directed from a camera to a media content switcher over a network. In another example, a local media signal control device may perform a file format compression on a media content signal as it is directed from a camera to a media content switcher over a network. In yet another example, both file format transformation and compression may be performed.

A camera may include circuitry and/or mechanical elements to provide automated movement of the camera such that the direction of video acquisition can be modified electronically. Examples of such circuitry and mechanical elements are well known. A control command can be sent from a media controller for changing a position (and/or zoom or other setting) of a camera. A local media signal control device may also be configured (e.g., with circuitry and/or machine executable instructions) to provide an instruction to a camera to change a position (and/or zoom or other setting) of a camera.

One or more cameras 110 are shown in FIG. 1 as being in the same location. It is contemplated that one or more cameras 110 may be disbursed at a plurality of locations that are each remote from media content switcher 105. In one example, each camera location includes a connection to network(s) 115 (e.g., to a public network). In one such example, each camera location includes a local media signal control device.

System 100 may also include a static media content device. A static media content device is a device located remote from the media content switcher. The static media content device includes a non-live stored media content. Examples of a static media content device include, but are not limited to, a content storage source (as described above), a memory element, and any combinations thereof. In one example, a static media content device is located at the location of the one or more cameras 110 and provides one or more media content signals via network 115 to media content switcher 105. In another example, a static media content device is included in system 100 in place of one or more cameras 110 and is connected to network 115 to provide one or more media content signals to media content switcher 105.

Media controller 120 can be any control device and/or user interface capable of providing one or more control signals to media content switcher 105. In one exemplary implementation, media controller 120 is capable of being positioned at a location that is remote from the location of media control switcher 105 and remote from the location of the one or more cameras 115. Example locations for media controller 120 include, but are not limited to, a location that is remote from media control switcher 105 but that is the same as the location of one or more cameras 110, a location that is remote from media control switcher 105 and remote from one or more cameras 110; and a location that is the same as the location of media control switcher 105 and that is remote from the location of one or more cameras 110. In one example, media controller 120 is remote from media content switcher 105. In another example, media controller 120 is remote from media content switcher 105 and one or more cameras 110. Components of a media controller may be disbursed at different geographic locations and connected via a network (e.g., a public network). In one such example, one or more components of a media controller that are for direct interaction with a user (e.g., a display device, an input device for receiving input from a user) are positioned at a location that is remote from media content switcher 105. In another such example, one or more components of a media controller that are for direct interaction with a user (e.g., a display device, an input device for receiving input from a user) are positioned at a location that is remote from media content switcher 105 and one or more cameras 110.

It is noted that a media controller may also be referred to herein as a control client.

A media controller includes components that allow for a user to interact with a media content production system, such as system 100. Example components for a media controller include, but are not limited to, a computing device, a display device, a dedicated media content control panel, a dedicated touch screen device having a user interface for user interaction with the system, a web-based user interface, a dedicated graphical user interface, a joystick, and any combinations thereof. In one example, a media controller includes a computing device and a displayable user interface. In another example, a media controller includes a dedicated device for receiving input from a user and displaying a user interface to the user. Examples of a displayable user interface include, but are not limited to web-based interface displayable via a standard Internet browser, a web-based interface displayable via a local application that is configured to run on a computing device, a dedicated graphical interface configured to run on a computing device, a dedicated graphical interface configured to run on a dedicated control panel and display screen combination, and any combinations thereof. An example of a prior dedicated control panel is described in U.S. Pat. No. 8,028,317, the disclosure of which is incorporated herein. Characteristics and functionality of such a control panel can be added to a dedicated control panel of the current disclosure.

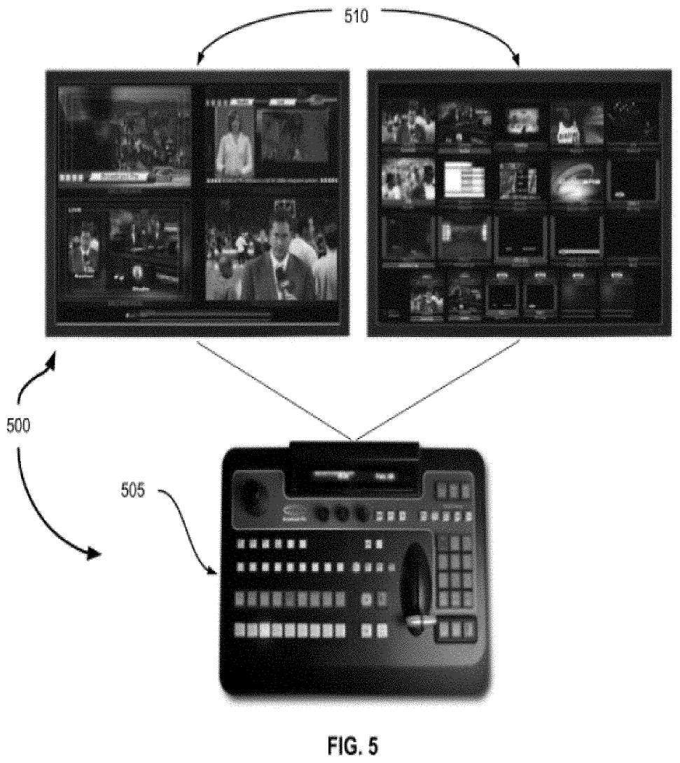

FIG. 5 illustrates one exemplary implementation of a media controller 500. Media controller 500 includes a dedicated control panel 505 and a display screen pair 510. Dedicated control panel 505 is shown as a hardware device panel connected to two display screens 510 for displaying activity of a media content switcher and interaction from control panel 505 in production of media content. Control panel 505 includes multiple buttons, each configured for one or more control features, multiple dials for interacting with media content production, and a control bar for activating video effects.

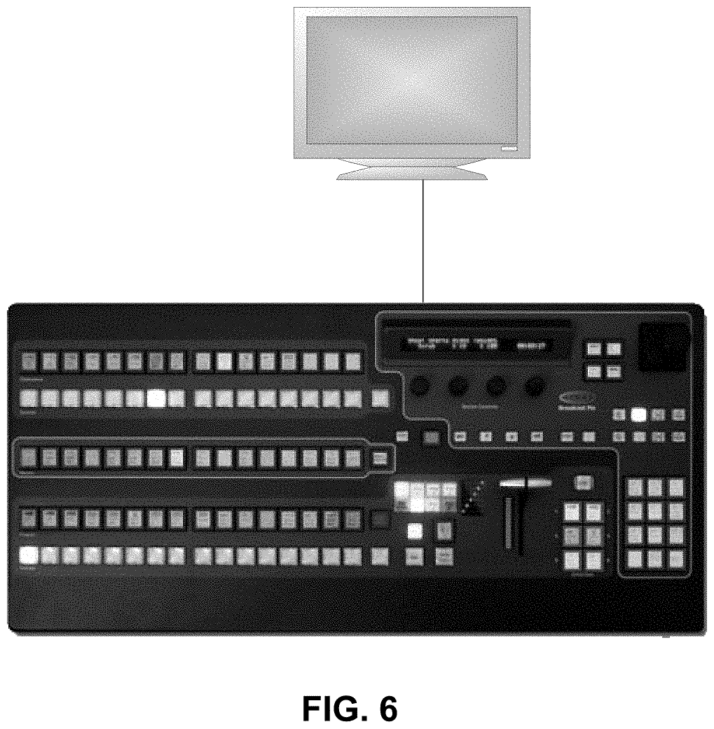

FIG. 6 illustrates another exemplary implementation of a media controller 600. Media controller 600 includes a dedicated control panel 605 and a display screen 610. Dedicated control panel 605 includes multiple buttons, each configured for one or more control features, multiple dials for interacting with media content production, and a control bar for activating video effects.

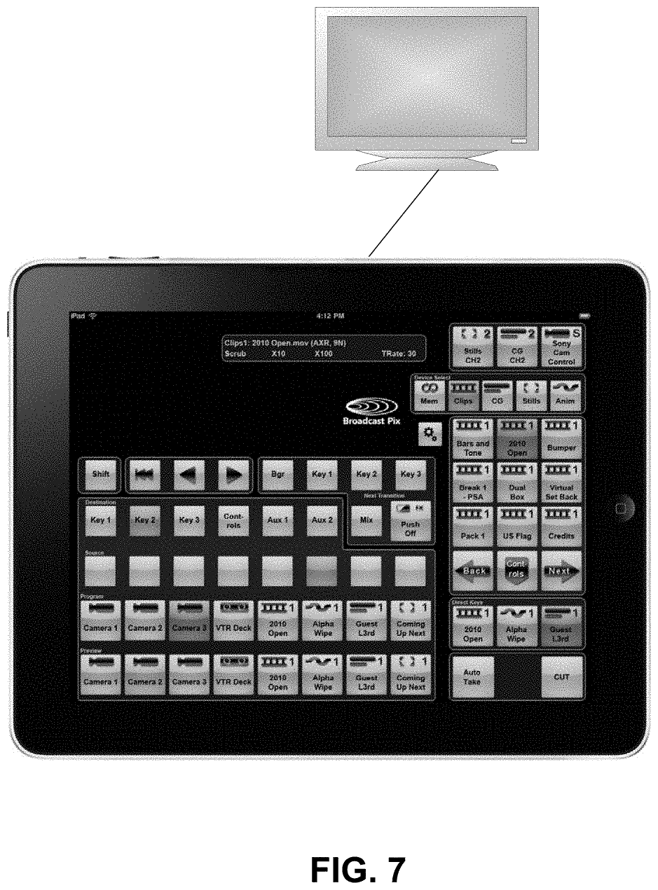

FIG. 7 illustrates yet another exemplary implementation of a media controller 700. Media controller 700 includes a computer device 705 (e.g., a tablet computer with touchscreen user input) connected to a display device 710. Computer device 705 includes a processor and a memory (not shown). The memory includes machine executable instructions for generating a user display 715 that provides graphical elements representing buttons and other user controls for interacting and controlling the media content production of a media content switcher. In one example, such graphical elements represent the same user interfaces provided by an existing dedicated hardware control panel. In another example, such graphical elements provide similar functionality to user interfaces provided by dedicated hardware control panels.

Each of media controllers 500, 600, 700 includes a connection to a network (e.g., a public network) capable of providing communication with a media content switcher (e.g., media content switcher 100), one or more cameras, and/or a local media signal control device. Examples of information provided over such communication paths is discussed throughout this disclosure.

For each of media controllers 500, 600, 700, a connection exists between display device(s) and control panel 505/control panel 605/computing device 705. Such a connection provides a user interface to be displayed to a user. Such a connection may include wireless and/or wired connectivity mechanisms. In one example, media controllers 500, 600, 700 include machine executable instructions (e.g., in the form of an application resident on such device) for providing such a user interface. In another example, a user interface is provided over a network (e.g., a public network) from another component of a media content production system (e.g., a media content switcher or associated computing device at the location of the media content switcher, a web server, an application server, etc.). In such an example, a direct connection between control panel/computing device and display device may be omitted and communication provided over a network connection (e.g., via a media content switcher or other remote computing device).

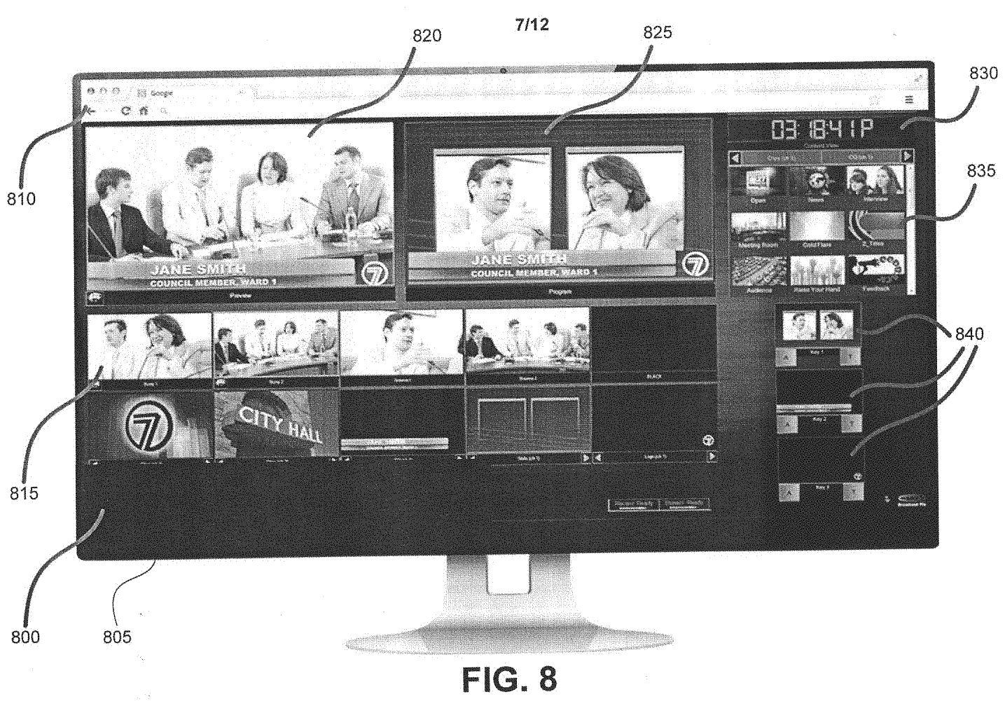

FIG. 8 illustrates one exemplary implementation of a media controller having a web-based user interface 800 for a media controller displayed via a display device 805. User interface 800 is displayed via a web browser application 810. User interface 800 includes multiple display portions for different purposes of interacting with a media content production and controlling a media content switcher and/or one or more cameras or other content sources. Region 815 includes a grid of 10 user-selectable portions in a 2×5 arrangement. Each user-selectable portion in Region 815 represents a media content input (e.g., a live media content signal from a camera, a recorded/stored media input from a content storage device, etc.) to a media content switcher. Region 815 includes five camera input selectable portions along the top row of region 815 and five media graphic content inputs selectable portions along the bottom row of region 815. A user can select one or these portions to preview it via portion 820, which is a preview monitor view of a selected media content input. A user may select one or more media content inputs for live program output from the media content switcher and feedback display to the user via “Program” portion 825. A user may select more than one media content input from region 815 to have them displayed simultaneously via preview portion 820 and/or to have the media content inputs become the live program output of the media content switcher and display via “Program” portion 825. User interface 800 also includes a time clock portion 830 displaying a digital time associated with the media content production. An available media content selection view portion 835 allows a user to view a collection of selectable stored media content and additional data that may be applied to the production media content product output. Button portions 840 provide user-selectable regions of the user interface for adding one or more effects to the preview media content and/or the output media content product.

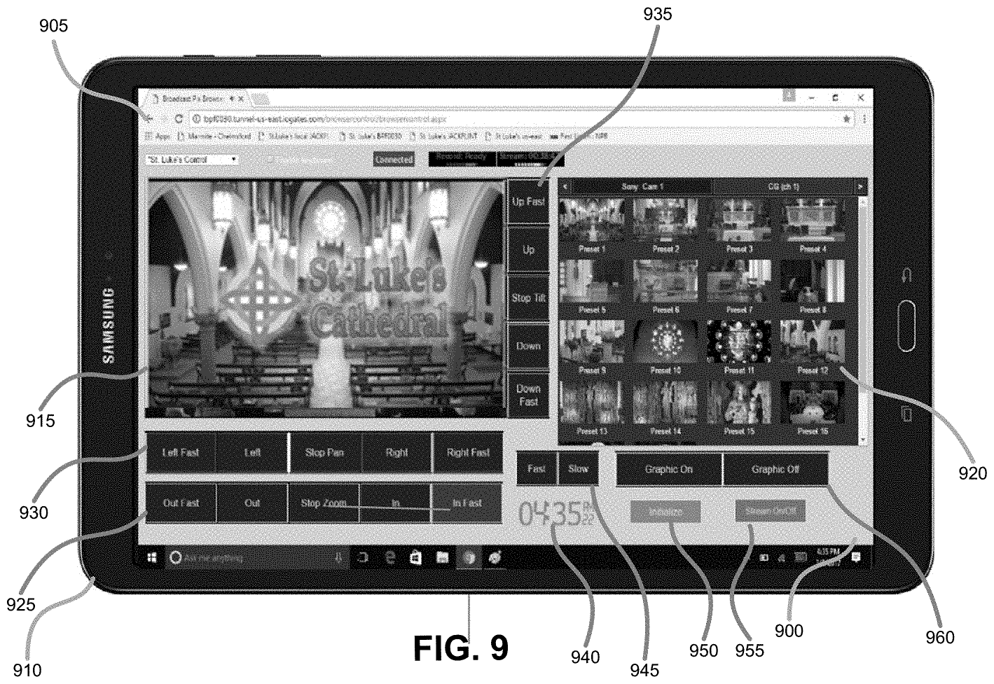

FIG. 9 illustrates another exemplary implementation of a media controller having a web-based user interface 900. User interface 900 is displayed via web browser application 905 on computing device mobile tablet 910. User interface 900 includes multiple display portions for different purposes of interacting with a media content production and controlling a media content switcher and/or one or more cameras or other content sources. “Program” portion 915 represents a live program output of a media content switcher. Region 920 includes a 4×4 grid of sixteen user-selectable portions, each for selecting a pre-programmed camera position for a camera that is providing a media content signal for production and output by the media content switcher (and display via portion 915). A user may select one of the portions in region 920 and the user interface transmits a control signal to a camera to reposition the camera to the preset position. In user interface 900, each of the user-selectable portions displays an image of where the camera was pre-programmed to aim in the scene to be viewed. A pre-programmed positioning may include a variety of settings for a camera. Example settings for a camera include, but are not limited to, a tilt position, a pan position, a zoom of a camera lens, another aim adjustment, and any combinations thereof. Region 925 includes five user-selectable portions for adjusting a zoom setting of a camera (zoom out fast, zoom out, stop zoom, zoom in, zoom in fast). Region 930 includes five user-selectable portion for adjusting pan positioning of a camera (pan left fast, pan left, stop pan, pan right, pan right fast). Region 935 includes five user-selectable portions for adjusting a tilt positioning of a camera (tilt up fast, tilt up, stop tilt, tilt down, tilt down fast). Manual adjustments (via portions of regions 925, 930, 935) and pre-programmed adjustments (via portions of region 920) of a camera can occur via a control instruction that is provided to the camera via one or more networks. In one example, a control instruction to a camera is communicated via a media content switcher connected via one or more networks to the user interface 900. In another example, a control instruction to a camera is communicated via one or more networks from user interface 900 to the camera without the need of communication via a media content switcher. In yet another example, a control instruction to a camera is communicated via an application server (e.g., a web server) associated with the system.

A digital clock portion 940 is also provided in user interface 900. Region 945 includes 2 user-selectable portions for setting a fast or slow effect for production. Portion 950 is a user-selectable button for initializing an aspect of the production. Portion 955 is a user-selectable button for turning the output of the media content switcher on and off. Region 960 includes two user-selectable portions for turning a graphic on and turning a graphic off. In this example, the graphic “St. Luke's Cathedral” is shown as being on via the “Program” output portion 915.

In one exemplary aspect of a web-based user interface (e.g., interfaces 800, 900), real-time video content monitoring and control via a media controller when done via a web-based interface may include rapid changes to a display of video (e.g., via a preview display, via a “Program” content output display), such as when a media content input change is made and/or when an effect to a media content is made. Having display updates occur in real-time with video input and video output from a media content switcher is an exemplary aspect of one or more of the user interface media controllers of the current disclosure.

A user interface, such as user interface 800, 900, may be user configurable. User configurability includes, but is not limited to, selection of user interface components (e.g., portions), location of user interface components in a display organization, configuration of one or more functionalities of a user interface component, configuration of one or more actions that occur when a component is selected by a user, and any combinations thereof. Example user interface components include, but are not limited to, a user selectable button, a button grid (e.g., of user selectable buttons), a clock display element (e.g., digital, analog), a content view component, a monitor component, a grid of monitor components, and any combinations thereof. A button component may initiate any one or more actions in controlling and/or otherwise interacting with a media content switcher and/or one or more cameras. A macro of multiple actions may be associated with a button or other user interface component. A user interface component (e.g., a button component) may include a display of an image representative of an action that may be instructed when a user selects the component. In one example, a button includes an image of a view of a camera position target. In another example, a button includes an image of a preview of data and/or special effect associated with the button. A content view component is a component providing a view of a content item (e.g., a stored content item) that is user selectable via a user interface for inclusion in a production. A monitor component is a component that provides a view of content (e.g., a live view of a live media content input signal, an view of a static media input, a preview display for readying a media content for output, a display of output media content product, etc.).

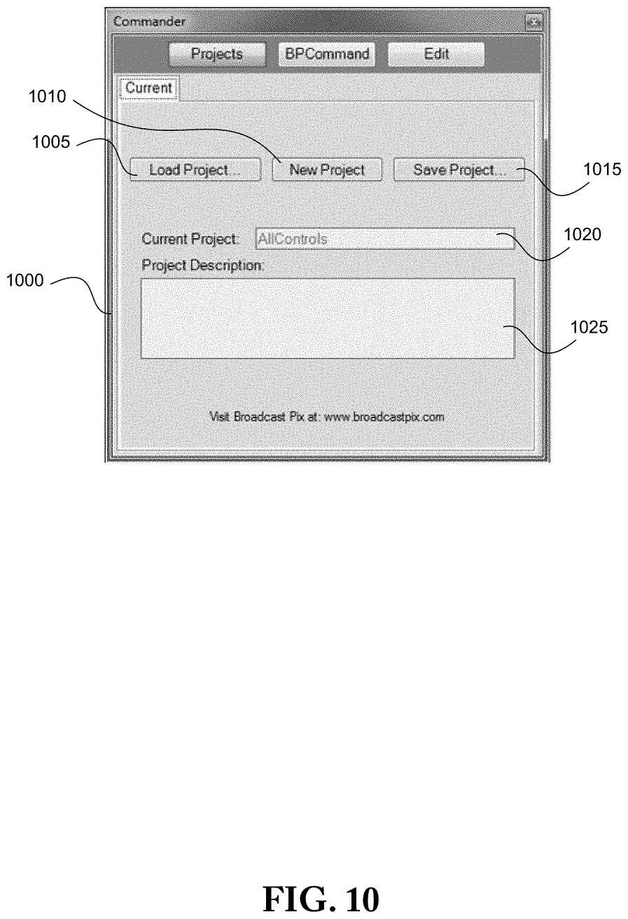

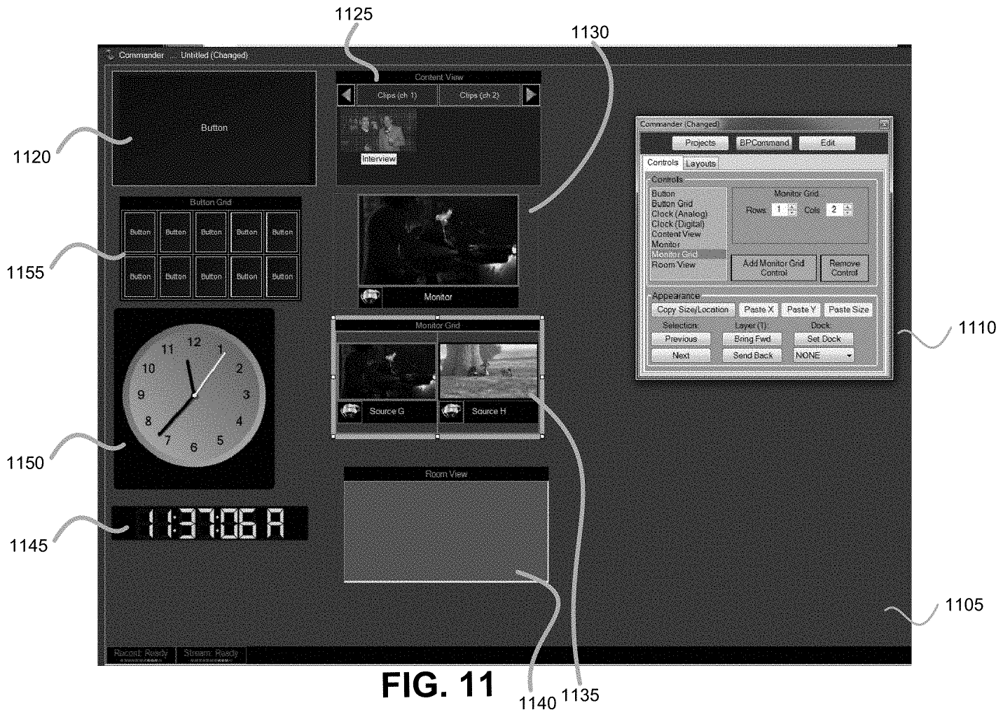

FIGS. 10 to 12 illustrate one exemplary implementation of a configuration interface for a media controller user interface. Such a configuration interface may be of a variety of formats. In one example, a configuration interface is a downloadable application based interface. In another example, a configuration interface is a web-based interface (e.g., implemented via a standard web browser application). The configuration interface and underlying system include machine executable instructions and appropriate circuitry (e.g., in combination with one or more of the devices of the current disclosure, such as a media content switcher, media controller, etc. or combinations thereof) to allow the user to interact with the configuration interface and for the modifications to the media controller user interface to be made, saved, and displayed back to the user with the modified location, attributes, functionality, etc. FIG. 10 illustrates an example of a selection display 1000 for selecting a user interface of a media controller (a “project”) for configuration. From this interface, an existing project may be loaded, a new project can be started, and a current open project can be saved. The interface includes the following user-selectable controls: a load project control 1005 to allow the user to select to load an existing configuration project, a new project control 1010 to allow the user to select to start a new configuration project, and a save project control 1015 to allow the user to save a current configuration project. Display 1000 also includes a current project title display field 1020 and a project description user input field 1025. FIG. 11 illustrates a view of a configuration interface 1105 showing multiple components placed in an organization on a display configuration (shown clockwise from top left corner): a button component 1120, a content view component 1125, a monitor component 1130, a monitor grid component (with two monitor components) 1135, a room view component 1140, a digital clock component 1145, an analog clock component 1150, and a button grid component (with ten button components) 1155. A configuration functionality interface 1110 is provided for setting up components and configuring features of the components. In this exemplary view, the monitor grid component 1135 is selected and the configuration functionality interface 1110 shows settings for a monitor grid, such as rows/columns, add/remove of component, appearance, etc.

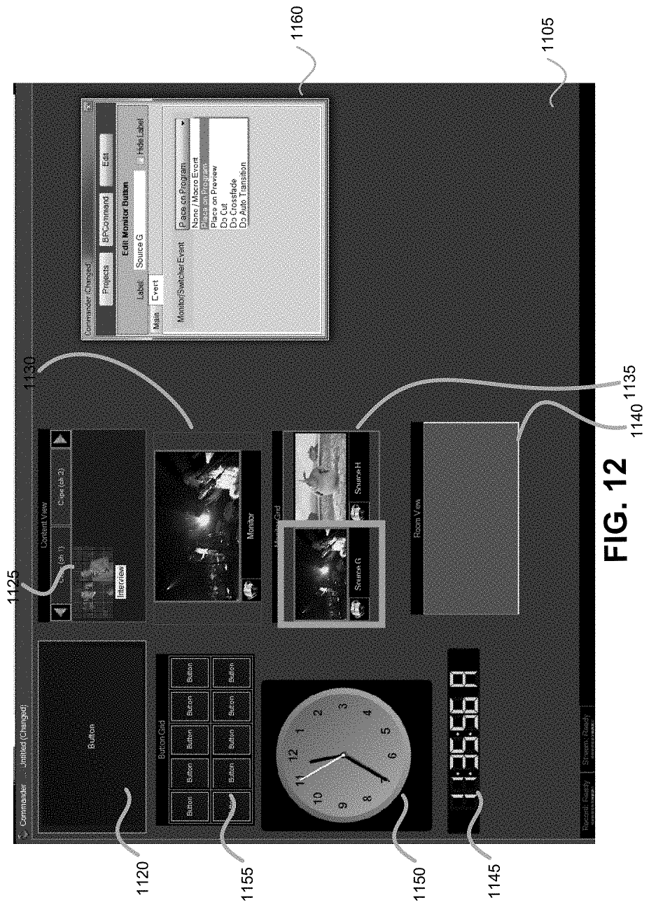

FIG. 12 shows another exemplary view of configuration interface 1105. In this view, one of the monitor components of the monitor grid component is selected (shown by light colored square box on component 1135) and a configuration functionality interface 1160 is displayed for configuring functionality of an event occurring when the monitor component is selected by a user. Other functionalities can be configured for each of the components using various configuration functionality interfaces similar to interface 1160, but having selections and configuration elements for the particular component.

Referring again to FIG. 1, system 100 may include a control client server (not shown) for providing a user interface to media controller 120. A user interface includes graphical display elements and user inputs for allowing a user to interact with the production process via the media controller communicating with the media content switcher (and/or one or more cameras).

Examples of an interaction between the media content switcher and the client device includes an interaction include, but are not limited to, providing at least one video signal based on the one or more source video signals from the media content switcher to the user interface, providing a control signal based on an input from a user via the user interface to the media content switcher, providing a camera operator information signal based on information input from a user via the user interface to an operator device located at the second location via the media content switcher, enter text, editing graphics, and any combinations thereof

Example user interfaces are discussed above. In one example, a control client server is a web server configured to provide a web-based interface to a media controller. In another example, a control client server is configured to provide a downloadable application to a media controller for providing a user interface to the media controller. In yet another example, a control client server provides information and connectivity for a dedicated application user interface on a media controller.

A control client server may be located at a variety of locations in system 100. Example locations for a control client server include, but are not limited to, at a location of a component of a media content switcher with connection to a network (e.g., a public network) via the component of the media content switcher, at a location of a component of a media content switcher with connection to the media content switcher component and to a network for communication to a media controller and/or one or more cameras, a location remote from a media content switcher with a connection to a network for communication to a media controller and a media content switcher (and/or one or more cameras), and any combinations thereof.

Referring again to FIG. 1, system 100 may also include a latency monitoring element (not shown) that has appropriate connections to the communication/connection path between one or more cameras 110 and media content switcher 105, and circuitry and/or machine executable instructions for monitoring the latency of two or more network paths between the location of the one or more cameras and the media content switcher and to determine the latency of each. Such latency information may be useful in a variety of situations (especially when using a public network) to minimize the time delay related to media content production and presentation of a produced content product (especially with real time media production where tolerances for content lag are lower). In one example, different network paths between the location of the camera(s) and the location of the media content switcher are available, and the paths have different latencies (e.g., due to router congestion, network path distance, network topology, poorly performing network components, etc.). In such an example, a latency monitoring element may measure the different latencies and direct media content signals from one or more cameras to the network path with the lower latency. In another example, media content switcher 105 may include two or more processing elements that are distributed across two or more distributed geographic locations. In such an example, a latency monitoring element may measure the latencies of sending signals to different distributed locations of a media content switcher to determine the location with a lower latency. The latency monitoring element may direct media content signals from one or more cameras to a location with a lower latency.

Example ways of determining latency include, but are not limited to, using a time stamp on media content signals as they are communicated from one or more cameras to a component of a media content switcher, sending a separate signal from a media content signal from a location of the one or more cameras to a location of a medic content switcher to determine time of transmission, sending a separate signal from a media content signal from a location of a media content switcher to a location of one or more cameras to determine time of transmission, and any combinations thereof.

In one example, a latency monitoring element is part of a local media signal control device. In one such example, a local media signal control device includes a connection to one or more cameras at the location, a connection to a public network, a processor, appropriate circuitry, and/or machine executable instructions for checking latency of a connection and selecting a proper network path.

In another example, a latency monitoring element is part of a media content switcher.

Display video (and/or audio) for a media controller may be provided to a media controller over one or more networks. Examples of ways for providing display video (and/or audio) to a media controller include, but are not limited to, providing media content to a media content switcher which provides the media content to a media controller, providing media content directly from a location of a camera via one or more networks to a media controller, reducing a size of a media content signal (e.g., reducing video resolution) for transmission and display, and any combination thereof. Display media content may be provided to a media controller by a local media signal control device.

Referring again to FIG. 1, a media content switcher may output a produced media content in any of a variety of media formats to any type of destination. Example destinations include, but are not limited to, a media broadcast, a network stream, a memory device, an Internet service (e.g., YouTube, Instagram, Facebook, Twitter, etc.), a display monitor, and any combinations thereof.

It is to be noted that any one or more of the aspects and embodiments described herein may be conveniently implemented using one or more machines (e.g., one or more computing devices that are utilized as a user computing device for an electronic document, one or more server devices, such as a document server) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk (e.g., a conventional floppy disk, a hard drive disk), an optical disk (e.g., a compact disk “CD”, such as a readable, writeable, and/or re-writable CD; a digital video disk “DVD”, such as a readable, writeable, and/or rewritable DVD), a magneto-optical disk, a read-only memory “ROM” device, a random access memory “RAM” device, a magnetic card, an optical card, a solid-state memory device (e.g., a flash memory), an EPROM, an EEPROM, and any combinations thereof. Such examples are hardware storage media. A machine-readable medium, as used herein, is intended to include a single medium as well as a collection of physically separate media, such as, for example, a collection of compact disks or one or more hard disk drives in combination with a computer memory. As used herein, a machine-readable storage medium does not include a signal.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

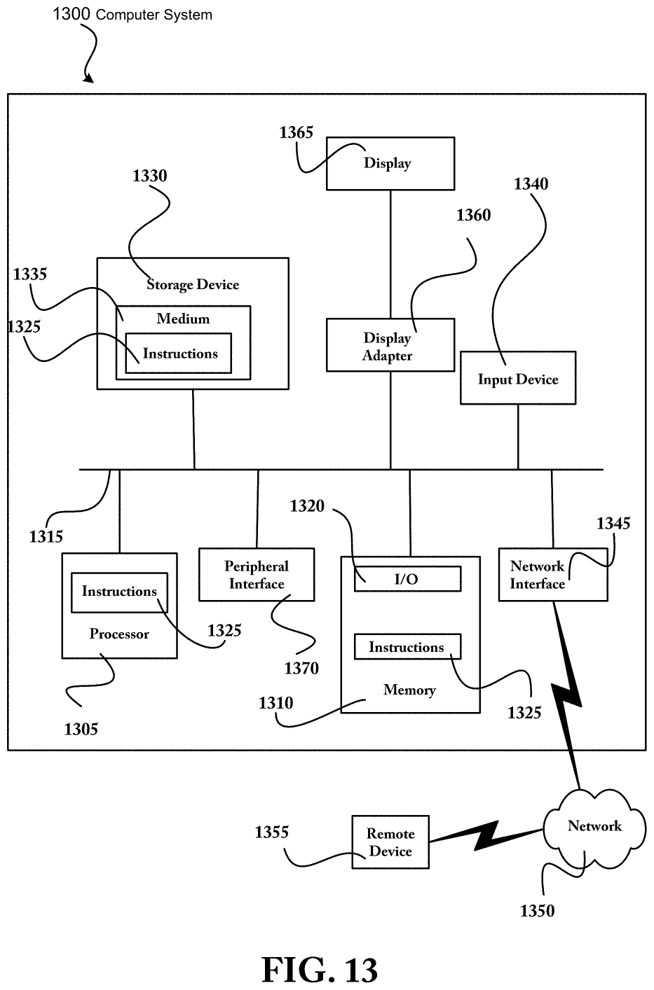

FIG. 13 shows a diagrammatic representation of one embodiment of a computing device in the exemplary form of a computer system 1300 within which a set of instructions for causing the device to perform any one or more of the aspects and/or methodologies of the present disclosure may be executed. It is also contemplated that multiple computing devices may be utilized to implement a specially configured set of instructions for causing the device to perform any one or more of the aspects and/or methodologies of the present disclosure. FIG. 13 shows only one example of a computing device, a computing device may include any number of well known components, including any one or more of the components shown in FIG. 13. Any such device or combination of devices constitutes a specially programmed machine for the functionalities of the current disclosure (e.g., an electronic clinical trial protocol management systems). Computer system 1300 includes a processor 1305 and a memory 1310 that communicate with each other, and with other components, via a bus 1315. Bus 1315 may include any of several types of bus structures including, but not limited to, a memory bus, a memory controller, a peripheral bus, a local bus, and any combinations thereof, using any of a variety of bus architectures.

Memory 1310 may include various components (e.g., machine readable media) including, but not limited to, a random access memory component (e.g., a static RAM “SRAM”, a dynamic RAM “DRAM”, etc.), a read only component, and any combinations thereof. In one example, a basic input/output system 1320 (BIOS), including basic routines that help to transfer information between elements within computer system 1300, such as during start-up, may be stored in memory 1310. Memory 1310 may also include (e.g., stored on one or more machine-readable media) instructions (e.g., software) 1325 embodying any one or more of the aspects and/or methodologies of the present disclosure. In another example, memory 1310 may further include any number of program modules including, but not limited to, an operating system, one or more application programs, other program modules, program data, and any combinations thereof.

Computer system 1300 may also include a storage device 1330. Examples of a storage device (e.g., storage device 1330) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 1330 may be connected to bus 1315 by an appropriate interface (not shown). Example interfaces include, but are not limited to, SCSI, advanced technology attachment (ATA), serial ATA, universal serial bus (USB), IEEE 1394 (FIREWIRE), and any combinations thereof In one example, storage device 1330 (or one or more components thereof) may be remotely interfaced with computer system 1300 (e.g., via an external port connector (not shown)). Particularly, storage device 1330 and an associated machine-readable medium 1335 may provide nonvolatile and/or volatile storage of machine-readable instructions, data structures, program modules, and/or other data for computer system 1300. In one example, software 1325 may reside, completely or partially, within machine-readable medium 1335. In another example, software 1325 may reside, completely or partially, within processor 1305.

Computer system 1300 may also include an input device 1340. In one example, a user of computer system 1300 may enter commands and/or other information into computer system 1300 via input device 1340. Examples of an input device 1340 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 1340 may be interfaced to bus 1315 via any of a variety of interfaces (not shown) including, but not limited to, a serial interface, a parallel interface, a game port, a USB interface, a FIREWIRE interface, a direct interface to bus 1315, and any combinations thereof. Input device may include a touch screen interface that may be a part of or separate from display 1365, discussed further below.

A user may also input commands and/or other information to computer system 1300 via storage device 1330 (e.g., a removable disk drive, a flash drive, etc.) and/or a network interface device 1345. A network interface device, such as network interface device 1345 may be utilized for connecting computer system 1300 to one or more of a variety of networks, such as network 1350, and one or more remote devices 1355 connected thereto. Additionally, a computer device may include a network interface device for receiving and/or transmitting data and/or other information from/to one or more other devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1350, may employ a wired and/or a wireless mode of communication. In general, any network topology may be used. Information (e.g., data, software 1325, etc.) may be communicated to and/or from computer system 1300 via network interface device 1345.

Computer system 1300 may further include a video display adapter 1360 for communicating a displayable image to a display device, such as display device 1365 (e.g., for providing user access to one or more user interfaces. Examples of a display device include, but are not limited to, a liquid crystal display (LCD), a cathode ray tube (CRT), a plasma display, a light emitting diode (LED) display, and any combinations thereof. In addition to a display device, a computer system 1300 may include one or more other peripheral output devices including, but not limited to, an audio speaker, a printer, and any combinations thereof. Such peripheral output devices may be connected to bus 1315 via a peripheral interface 1370. Examples of a peripheral interface include, but are not limited to, a serial port, a USB connection, a FIREWIRE connection, a parallel connection, and any combinations thereof.

It is noted that a system that includes a media content switcher at one location, one or more live sources at a second location, and a primary media controller at a third location involves control, delay, and system issues, such as the ones discussed above and resolved using one or more combinations of the concepts discussed herein. Differing embodiments provide various different benefits. Example benefits include centralization of expensive and potentially underutilized processing resources (e.g., having one or more media content switchers located remotely from other components, having one or more media content switchers located remotely from other components to serve multiple other combinations of media controllers and camera locations, etc.); allowing a production to be produced without having to bring skilled operators to a live source or media switcher location (e.g., by having operators remotely located with media controllers); the ability to support multiple source and/or control locations where live events might occur without having to move all needed resources to the one or more locations, and many others.

In the example systems and methods listed above, any feature from one system or method is contemplated to be able to be combined with a feature of another system or method where such combination is possible without detriment to the system or method. Thus, multiple combinations are possible that are not shown expressly.

In general, the systems, methods, compounds, compositions, etc. of the present invention have been exemplified by various exemplary embodiments and implementations as shown in the accompanying drawings and as described above. However, it should be understood that the presentation of these embodiments and implementations should not be construed as requiring that: 1) these embodiments and implementations stand in isolation from one another; 2) that individual components, features, aspects, and/or functionalities described relative to each one of the embodiments and implementations cannot be used independently of the corresponding embodiment or implementation; and 3) that individual components, features, aspects, and/or functionalities described cannot be used individually in connection with other embodiments and implementations, either described herein or derivable therefrom, alone and/or in any combination with one another. On the contrary, those skilled in the art will appreciate that the individual components, features, aspects, and functionalities of a particular embodiment or implementation can, as appropriate under the circumstances, be utilized alone and in any subcombination with other components, features, aspects, and/or functionalities of that particular embodiment or implementation and with any other embodiment or implementation, including the specific examples described herein.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed:

1. A system for processing video input, the system comprising:
a media content switcher positioned at a first location and having a first connection to a public network;
one or more video signal connections configured to provide one or more source video signals over the public network to the media content switcher, the one or more source video signals being from one or more cameras located at a second location remote from the first location;
a media controller configured to be positioned at a third location remote from the first location and the second location, the media controller providing an interface to a user for controlling the selection of the one or more source video signals and the processing of the one or more source video signals with one or more media effects, the media controller connected to the media content switcher over the public network;
a media controller server configured to communicate with the media content switcher and provide a user interface via the media controller for a user to interact with the media content switcher, wherein the media controller server includes a web server configured to provide a user interface via a web browser application of a client device, the web server in communication with the media content switcher via the public network and/or a private network for providing interaction between the media content switcher and the client device, wherein the interaction between the media content switcher and the client device includes an interaction selected from the group consisting of providing at least one video signal based on the one or more source video signals from the media content switcher to the user interface, providing a control signal based on an input from a user via the user interface to the media content switcher, providing a camera operator information signal based on information input from a user via the user interface to an operator device located at the second location via the media content switcher, enter text, for editing graphics, and any combinations thereof; and
a latency monitoring element, the latency monitoring element configured to monitor the latency of a plurality of network paths between the second location and the first location and to direct each of the one or more source video signals over a chosen one or more of the plurality of network paths to minimize latency of the one or more source video signals wherein the latency monitoring element includes a memory device having machine executable instructions for comparing time codes and/or network path encodings associated with the one or more source video signals to determine a lower latency network path.

2. A system according to claim 1, wherein the first location includes two or more distributed locations that are each remote from the second location, the media content switcher including two or more distributed processing elements that are distributed across the two or more distributed locations.

3. A system according to claim 1, wherein the latency monitoring element is at least partially included as part of the media content switcher.

4. A system according to claim 1, wherein the media content switcher is also configured to receive via the public network one or more audio signals from the second location, the one or more audio signals being coordinated with the one or more source video signals.

5. A system according to claim 1, wherein the one or more video signal connections includes a router device configured for connection to the one or more cameras via a wired connection and/or a wireless connection, the router device including a first port to the public network and one or more second ports for connection to the one or more cameras.
